(19) United States
(12) Patent Application Publication
(10) Pub. No.: US 2023/0298047 A1
(43) Pub. Date: Sep. 21, 2023

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Toyokazu NAKASHIMA, Nagoya-shi (JP); Shunsuke SAGARA, Nisshin-shi (JP); Naoya OKA, Nagakute-shi (JP)

(21) Appl. No.: 18/150,250

(22) Filed: Jan. 5, 2023

(30) Foreign Application Priority Data
Mar. 18, 2022 (JP) 2022-043834

(51) Int. Cl. G06Q 30/018; G06Q 10/0834

(52) U.S. Cl. CPC G06Q 30/018; G06Q 10/0834

(57) ABSTRACT

A control unit is provided that is configured to receive, from a user terminal, a request to send information to be displayed on a screen for making selections about delivery of a product and, in response to the request, to output information that is to be displayed on the screen for making selections about delivery of a product and that is about an amount of carbon dioxide. The amount of carbon dioxide corresponds to items selectable by a user who purchases the product and is emitted from a vehicle that delivers the product.

### CROSS-REFERENCE TO RELATED APPLICATION

This application claims priority to Japanese Patent Application No. 2022-043834 filed on Mar. 18, 2022, incorporated herein by reference in its entirety.

### BACKGROUND

### 1. Technical Field

The present disclosure relates to an information processing device and an information processing method.

### 2. Description of Related Art

There is a technique to present to a user a food product cooking method and greenhouse gas emissions that will result by cooking the food product according to the cooking method (for example, Japanese Unexamined Patent Application Publication No. 2010-044667 (JP 2010-044667 A)).

### SUMMARY

It is an object of the present disclosure to reduce the amount of carbon dioxide emitted from a vehicle at the time of product delivery.

A first aspect of the present disclosure relates to an information processing device including a control unit. The control unit is configured to receive, from a user terminal, a request to send information to be displayed on a screen for making selections about delivery of a product and, in response to the request, to output information that is to be displayed on the screen for making selections about delivery of a product and that is about the amount of carbon dioxide. The amount of carbon dioxide corresponds to items selectable by a user who purchases the product and is emitted from a vehicle that delivers the product.

A second aspect of the present disclosure relates to an information processing method performed by a computer. The information processing method includes receiving, from a user terminal, a request to send information to be displayed on a screen for making selections about delivery of a product and, in response to the request, outputting information that is to be displayed on the screen for making selections about delivery of a product and that is about the amount of carbon dioxide. The amount of carbon dioxide corresponds to items selectable by a user who purchases the product and is emitted from a vehicle that delivers the product.

A still another aspect of the present disclosure is a program that causes a computer to execute the information processing method described above, or a storage medium in which the program is stored in a non-transitory manner.

According to the present disclosure, the amount of carbon dioxide emitted from a vehicle at the time of product delivery can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a system according to an embodiment;

FIG. 2 is a block diagram schematically showing an example of a configuration of each of a user terminal, a delivery server, and a sales server that constitute the system according to the embodiment;

FIG. 3 is a diagram showing an example of functional components of the user terminal, delivery server, and sales server according to the embodiment;

FIG. 4 is a diagram showing an example of a screen on which a user specifies a delivery method when the user purchases a product;

FIG. 5 is a diagram showing an example of a configuration of data stored in a CO₂ information DB; and

FIG. 6 is a flowchart showing processing for displaying an amount of increase or decrease from a standard amount in CO₂ emissions corresponding to a product delivery method according to the embodiment.

### DETAILED DESCRIPTION OF EMBODIMENTS

An information processing device, which is one aspect of the present disclosure, includes a control unit. The control unit is configured to receive, from a user terminal, a request to send information to be displayed on a screen for making selections about delivery of a product and, in response to the request, to output information that is to be displayed on the screen for making selections about delivery of a product and that is about the amount of carbon dioxide. The amount of carbon dioxide corresponds to items selectable by a user who purchases the product and is emitted from a vehicle that delivers the product.

A product is, for example, a product that can be purchased at an online shop (a website that sells products). The information displayed on the screen for making selections about delivery of a product is, for example, the information to be displayed on a user terminal. The items selectable by the user who purchases a product are items that can be specified by the user for the delivery of the product. Those items are used to specify a delivery date, a delivery timeslot, a delivery business operator, and a receiving method such as unattended delivery or delivery to locker. When the user selects these items, the control unit presents to the user how much carbon dioxide will be emitted.

For example, when a user purchases a product at an online shop, the product is shipped from the delivery source for delivery to the delivery destination. The product is delivered by a vehicle. Carbon dioxide emitted from the vehicle is a substance that is emitted by the operation of the internal combustion engine and is contained in the exhaust gas from the internal combustion engine. Carbon dioxide is a substance for which it is desired to reduce emissions. Carbon dioxide emissions can be reduced, for example, by shortening the travel distance of the vehicle or by reducing the load on the vehicle. In addition, carbon dioxide emissions are correlated with a vehicle type. This means that carbon dioxide emissions at package delivery time can vary depending on the vehicles owned by the delivery business operator. When a delivery business operator can be specified at the time of product purchase, the carbon dioxide emissions during product delivery can be reduced by specifying a delivery business operator that owns many vehicles with low carbon dioxide emissions.

In addition, when the user is not at home when a product is delivered, it may be necessary to redeliver the product. Redelivery of a product increases the distance that the product is transported by a vehicle, leading to an increase in the amount of carbon dioxide emitted for transporting the product. By specifying a delivery date and a delivery date and time, the possibility that the package is delivered when the user is at home is increased. However, in a situation in which the user suddenly has to go out or is very busy at home, the user may not receive a package. In this case, carbon dioxide emissions may increase. In addition, depending on the date or the timeslot specified by the user, carbon dioxide emissions may increase due to traffic congestion.

On the other hand, when a delivery locker is provided at the delivery destination or unattended delivery is specified, redelivery is not necessary even if the user is not at home. Therefore, specifying non-face-to-face delivery of a product (for example, delivery to locker or unattended delivery) at the time of product purchase can reduce carbon dioxide emissions.

With these factors in mind, the control unit displays the information that corresponds to the items selectable by the user and that is about the amount of carbon dioxide, for example, on the screen for making selections about delivery of a product. This information, when displayed, allows the user to know, before purchasing a product, the amount of carbon dioxide that will be emitted during the delivery of the product. For example, since carbon dioxide emissions can vary depending on the package receiving method specified by the user, the delivery business operator specified by the user, the day specified by the user, and the timeslot specified by the user, the carbon dioxide emissions displayed on the user's screen can also vary.

When a user is conscious of reducing carbon dioxide emissions, it is more likely that the user specifies a product delivery method that will reduce carbon dioxide emissions. For example, the user can reduce carbon dioxide emissions by specifying unattended delivery. The user can also select a day or a timeslot with low carbon dioxide emissions. When carbon dioxide emissions can be reduced by not specifying a particular day or a particular timeslot, the user is more likely to omit these items. Furthermore, the user may select a delivery business operator that emits less carbon dioxide. Selecting a delivery business operator in this way may lead delivery business operators to use vehicles with low carbon dioxide emissions. This can also reduce carbon dioxide emissions.

Embodiments of the present disclosure will be described with reference to the drawings. Note that the embodiment configuration given below is exemplary and that the present disclosure is not limited to this embodiment configuration. In addition, the embodiments given below can be combined as much as possible.

### First Embodiment

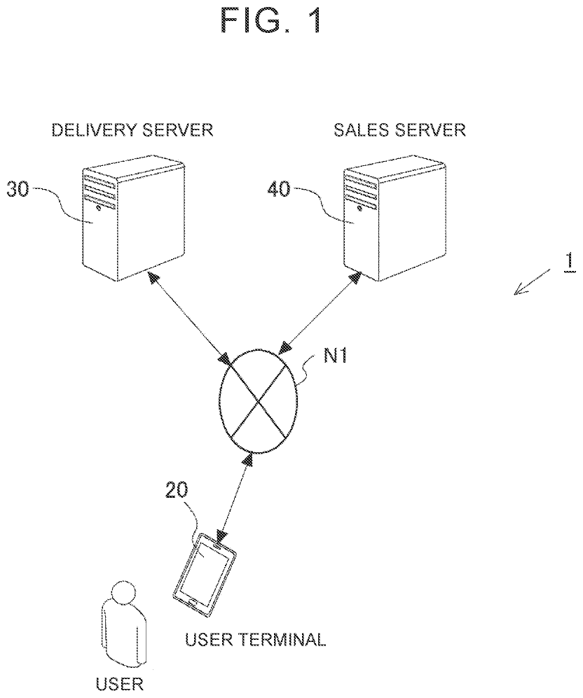

FIG. 1 is a diagram showing a schematic configuration of a system 1 according to this embodiment. The system 1 includes a user terminal 20, a delivery server 30, and a sales server 40. The system 1 is a system that, when a user is going to purchase a product at a shop on the web, displays the amount of increase or decrease from the standard amount in carbon dioxide emissions (hereinafter also referred to as CO₂ emissions), emitted from the delivery vehicle at the time of delivery of the product, on a web page according to the items selected by the user. This standard amount may be an average value.

The sales server 40, a computer that conducts electronic commerce, carries out a transaction of products with the user terminal 20. The sales server 40 performs processing for receiving a product order from the user terminal 20 and performs processing for delivering the ordered product to the user. In addition, the sales server 40 performs processing for notifying the delivery server 30 of the name of a product to be delivered and the delivery destination and, at the same time, performs processing for requesting it to deliver the product.

The sales server 40 manages shops (online shops) on the web. In response to a request from the user terminal 20, the sales server 40 displays a web page (product page) on the user terminal 20 for the user to purchase a product. In addition, in response to a request from the user terminal 20, the sales server 40 displays product search results or a shopping cart page on the user terminal 20.

In addition, the sales server 40 makes online payment based on the information obtained from the user terminal 20. Instead of online payment, the payment of a product may be made on a cash on delivery basis or on a deferred payment basis. The sales server 40 also requests the delivery server 30 to deliver a product, purchased by the user, to a location specified by the user. A known technique can be used for the payment at the time of purchase and for the arrangement of delivery.

When the user purchases a product, the sales server 40 asks the user to enter the delivery information. For example, the sales server 40 displays the options for each of the delivery date, delivery business operator, delivery timeslot, and receiving method on the user terminal 20. At this time, the sales server 40 displays on the user terminal 20 the amount of increase or decrease from the standard amount in CO₂ emissions corresponding to each of the options. This will be discussed later.

Next, when a request for product delivery is received from the sales server 40, the delivery server 30 generates a vehicle operation plan for transporting the product from the product delivery source to the delivery destination. The vehicle may be a vehicle capable of autonomous driving or a vehicle manually driven by a driver. For a vehicle manually driven by a driver, the operation plan is sent to the driver's terminal of the vehicle, or to the terminal of the vehicle, for displaying the route on the terminal. For a vehicle capable of autonomous driving, the operation plan is sent to the vehicle to allow the vehicle to travel autonomously according to this operation plan. Since existing services such as a home delivery service can be used, the description of delivery by vehicle is omitted.

The user terminal 20, a terminal used by a user, has the function to allow the user to purchase a product at an online shop. The user can place an order for a product with an online shop, for example, via a web browser. The user terminal 20 presents to the user the information on CO₂ emissions corresponding to the delivery when the user purchases a product. This information is obtained from the sales server 40.

The user terminal 20, delivery server 30, and sales server 40 are interconnected by a network N1. The network N1, which is a worldwide public communication network such as the Internet, may be a wide area network (WAN) or any other communication network. The network N1 may also include a telephone communication network for mobile phones or a wireless communication network such as Wi-Fi (registered trademark). Although one delivery server 30 is shown in FIG. 1 as an example, two or more delivery servers 30 may be used. The delivery server 30 may be provided for each delivery business operator or for each sales office of a delivery business operator. There may also be a plurality of users and user terminals 20.

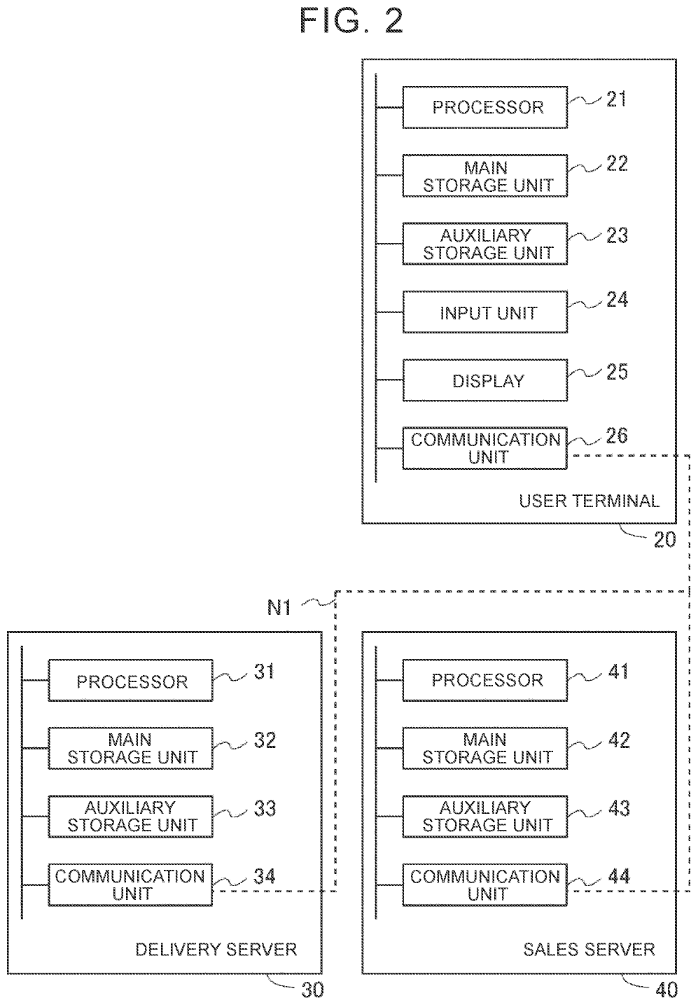

Next, with reference to FIG. 2, the hardware configuration of the user terminal 20, delivery server 30, and sales server 40 will be described. FIG. 2 is a block diagram schematically showing an example of the configuration of each of the user terminal 20, delivery server 30, and sales server 40 of the system 1 according to this embodiment.

The sales server 40 has a configuration of a computer. The sales server 40 includes a processor 41, a main storage unit 42, an auxiliary storage unit 43 and a communication unit 44. These units are interconnected by a bus. The processor 41 is an example of a control unit.

The processor 41 is a processor such as a central processing unit (CPU) and a digital signal processor (DSP). The processor 41 controls the sales server 40 to perform various types of information processing operations. The main storage unit 42 is a memory such as a random access memory (RAM) and a read only memory (ROM). Examples of the auxiliary storage unit 43 include an erasable programmable ROM (EPROM), a hard disk drive (HDD), and a removable medium. The auxiliary storage unit 43 stores an operating system (OS), various programs, and various tables. The processor 41 loads programs from the auxiliary storage unit 43 into the work area of the main storage unit 42 for execution and, through the execution of these programs, controls the components. Through this operation, the sales server 40 implements the functions satisfying the intended purpose. The main storage unit 42 and the auxiliary storage unit 43 are computer-readable storage media. The sales server 40 may be a single computer or a combination of a plurality of computers. The information stored in the auxiliary storage unit 43 may also be stored in the main storage unit 42. Conversely, the information stored in the main storage unit 42 may be stored in the auxiliary storage unit 43.

The communication unit 44 is a unit for communicating with the user terminal 20 and the delivery server 30 via the network N1. The communication unit 44 is, for example, a local area network (LAN) interface board and a wireless communication circuit for wireless communication. The LAN interface board and the wireless communication circuit are connected to the network N1.

A series of processing performed by the sales server 40 can be performed not only by hardware but also by software.

Next, the user terminal 20 will be described. The user terminal 20 is, for example, a small computer such as a smartphone, a mobile phone, a tablet terminal, a personal information terminal, a wearable computer (such as a smart watch), or a personal computer (PC). The user terminal 20 includes a processor 21, a main storage unit 22, an auxiliary storage unit 23, an input unit 24, a display 25 and a communication unit 26. These units are interconnected by a bus. Since the processor 21, main storage unit 22, and auxiliary storage unit 23 are the same as the processor 41, main storage unit 42, and auxiliary storage unit 43 of the sales server 40, the description thereof is omitted.

The input unit 24 is a unit for receiving an input operation performed by a user such as a touch panel, a mouse, a keyboard, or push buttons. The display 25 is a unit for presenting information to the user such as a liquid crystal display (LCD) or an electroluminescence (EL) panel. The input unit 24 and the display 25 may be configured as one touch panel display.

The communication unit 26 is a communication unit for connecting the user terminal 20 to the network N1. The communication unit 26 is a circuit for communicating with other devices (for example, the sales server 40) via the network N1 using a wireless communication network such as a mobile communication service (telephone communication network, for example, fifth generation (5G), fourth generation (4G), third generation (3G), or Long Term Evolution (LTE) network), Wi-Fi (registered trademark), and Bluetooth (registered trademark).

The delivery server 30 has a configuration of a computer. The delivery server 30 includes a processor 31, a main storage unit 32, an auxiliary storage unit 33, and a communication unit 34. Since the processor 31, main storage unit 32, auxiliary storage unit 33, and communication unit 34 of the delivery server 30 are the same as the processor 41, main storage unit 42, auxiliary storage unit 43, and communication unit 44 of the sales server 40, the description thereof is omitted.

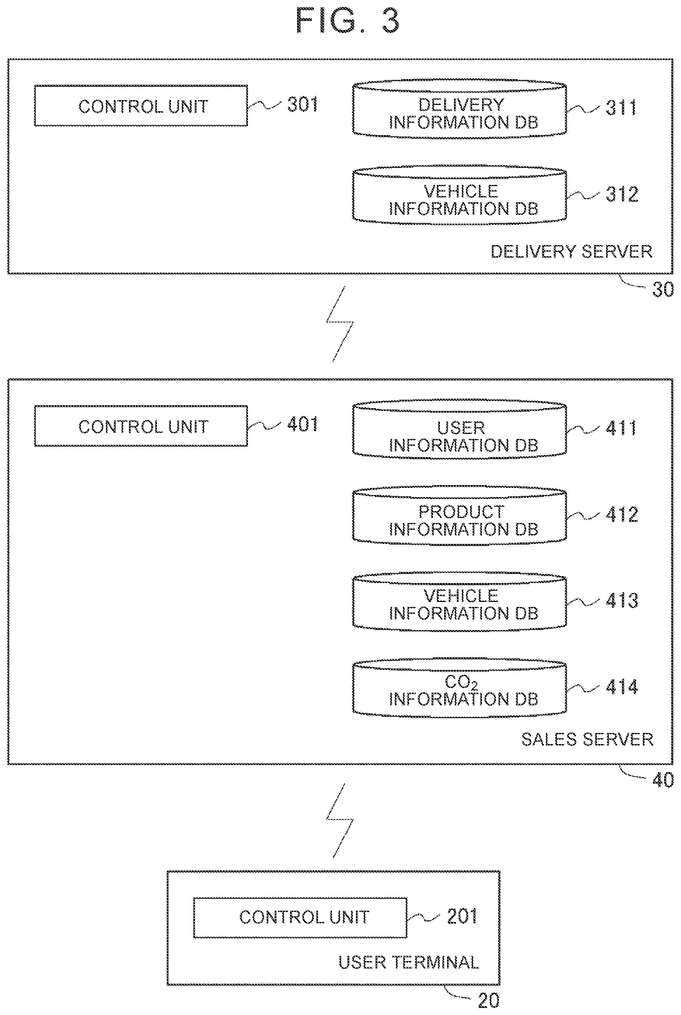

Next, the functional components of the user terminal 20, delivery server 30, and sales server 40 will be described. FIG. 3 is a diagram showing an example of functional components of the user terminal 20, delivery server 30, and sales server 40 according to this embodiment. The sales server 40 includes a control unit 401, a user information DB 411, a product information DB 412, a vehicle information DB 413, and a CO₂ information DB 414 as functional components. The processor 41 of the sales server 40 performs the processing of the control unit 401 according to the computer program in the main storage unit 42. Note that any one of the functional components or a part of its processing may be performed by a hardware circuit.

The user information DB 411, product information DB 412, vehicle information DB 413, and CO₂ information DB 414 are built by managing the data, stored in the auxiliary memory 43, by the program of the database management system (DBMS) executed by the processor 41. The user information DB 411, product information DB 412, vehicle information DB 413, and CO₂ information DB 414 are, for example, relational databases.

The control unit 401 sends the information on a product (hereinafter also referred to as product information) to the user terminal 20 that has accessed an online shop (which may be an EC site). The product information is the information used to display a product page on the display 25 of the user terminal 20. The product information includes the information on each of the description of a product and the price of the product. In addition, when the product is added to the shopping cart on the user terminal 20 and, after that, a predetermined purchase button for purchasing the product is tapped, a request to display a page to purchase the product (purchase page) is sent from the user terminal 20 to the sales server 40. The purchase page is a page used to enter the information such as the product delivery destination, payment method, and delivery method. In response to this request, the control unit 401 sends the information used to display the purchase page to the user terminal 20. The user enters (or selects) the delivery information on the purchase page. The delivery information is the information used to specify the information such as the delivery date, delivery business operator, delivery timeslot, and receiving method.

The screen for entering the delivery information displays the information on CO₂ emissions corresponding to the delivery date, delivery business operator, delivery timeslot, and receiving method that can be specified by the user. This information on CO₂ emissions includes, for example, the information on the difference between the amount of CO₂, emitted in order to transport the product from the warehouse, which is the delivery source where the product is stored, to the point that is the delivery destination specified by the user, and its average value. That is, this information informs the user how much CO₂ emissions will increase or decrease from the average value when the product is delivered by the delivery method selected by the user.

Although a product may be delivered via multiple sites, CO₂ emissions are affected mainly by a user's selection of the method of delivery from the user's nearest sales office to the product delivery destination (for example, the user's home). Therefore, in this embodiment, the amount of increase or decrease from the average value in CO₂ emissions emitted from the nearest sales office to the user's home is displayed on the display 25 of the user terminal 20 as the information on CO₂ emissions. It is assumed that the CO₂ emissions from the product delivery source to the nearest sales office are constant. This assumption simplifies the calculation.

In addition, as the amount of increase or decrease from the average value in CO₂ emissions, the control unit 401 calculates, not the amount of increase or decrease at the actual delivery destination of the product, but the average value of the amount of increase or decrease for the entire area, and provide the calculated average value. Thus, for example, multiple users living in the same area are provided with the same information on CO₂ emissions. This area is, for example, an area defined as an administrative area, an area divided by mesh, an area divided by delivery business operator, or an area covered by each sales office of a delivery business operator.

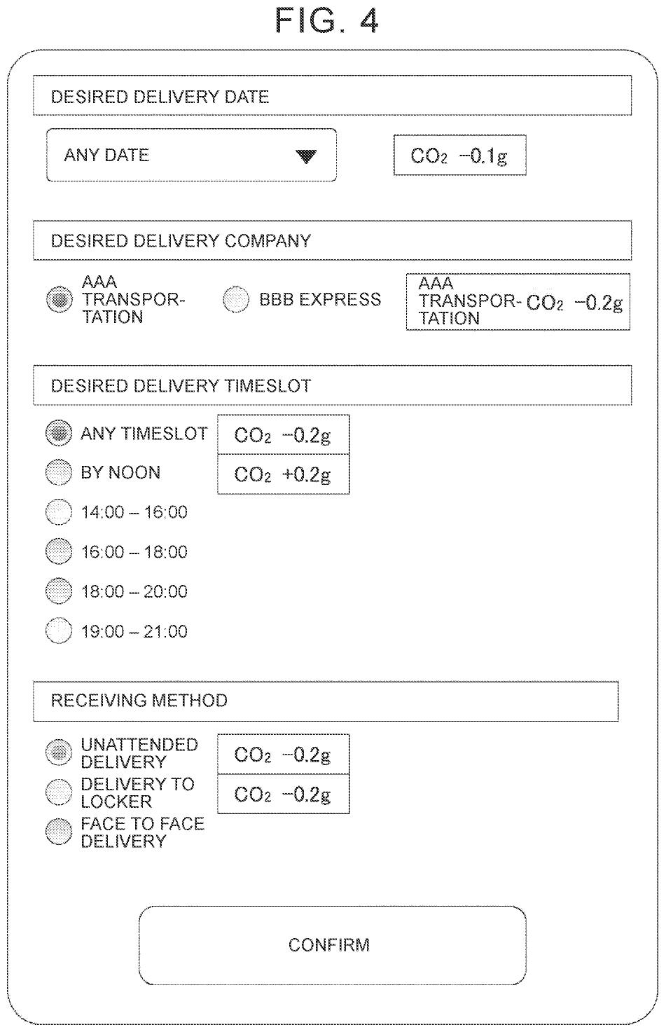

FIG. 4 is a diagram showing an example of the screen for specifying a delivery method when a user purchases a product. On this screen, the user enters the following four items: Desired Delivery Date, Desired Delivery Company, Desired Delivery Timeslot, and Receiving Method. This screen may be a part of the product purchase page or may be a page linked from the purchase page.

Below the item Desired Delivery Date, dates, days of the week, or ‘Any date’ is displayed. ‘Any date’ means that the user has no desired delivery date. For example, the user taps a desired delivery date from the pull-down menu (a menu in which options appear when the user taps). When there is no desired delivery date, the user just taps ‘Any date’. In this way, the user can select a day of the week or a day on which the product will be delivered when purchasing a product.

Note that congestion is likely to occur, or congestion does not occur, depending on a day of the week or on a day. This means that the CO₂ emissions of the vehicle that delivers the product may change depending on a day of the week, or on a day, specified by the user. Therefore, in this embodiment, the amount of increase or decrease from the standard amount in CO₂ emissions corresponding to the delivery date is displayed on the user terminal 20. For example, by comparing the average value of CO₂ emissions for all timeslots (that is, the average value of CO₂ emissions as a whole) with the average value of CO₂ emissions for each day of the week, the amount of increase or decrease in the CO₂ emissions corresponding to each day of the week can be calculated. Then, the amount of increase or decrease in the CO₂ emissions is applied based on what day of the week it is.

For example, in the example shown in FIG. 4, by selecting ‘Any date’ for the item Desired Delivery Date, the characters ‘CO_{2 -0.1} g’ are displayed on the right side. This indicates that CO₂ emissions are reduced by 0.1 g from the standard amount by not limiting the desired delivery date. The standard amount is, for example, the average value of CO₂ emissions for all deliveries. When ‘Any date’ is selected for Desired Delivery Date, the delivery business operator can select, for example, a day without traffic congestion to deliver the product. This can reduce the CO₂ emissions. In addition, the delivery business operator can deliver the product, for example, when a vehicle with low CO₂ emissions or a vehicle with no CO₂ emissions is available. This can also reduce the CO₂ emissions. Therefore, selecting ‘Any date’ for Desired Delivery Date results in the lowest CO₂ emissions.

When the user selects a predetermined day as the desired delivery date, the CO₂ emissions increase on a day when traffic congestion occurs, and decrease on a day when traffic congestion does not occur. Therefore, the sales server 40 calculates the difference from the standard amount in CO₂ emissions according to the desired delivery date and presents the calculated difference to the user.

Next, below the item Desired Delivery Company, the names of delivery business operators that can deliver the product are displayed. The user can select a delivery business operator, for example, by tapping a radio button corresponding to the desired delivery business operator. When the user selects a desired delivery company, the difference from the standard amount in CO₂ emissions is displayed according to the desired delivery company.

Since the types of vehicles owned by delivery business operators differ, the CO₂ emissions may vary depending on the selected delivery business operator. For example, when the delivery business operator owns only battery electric vehicles (BEV) or fuel cell electric vehicles (FCEV), the CO₂ emissions during delivery are zero. On the other hand, when the delivery business operator owns only vehicles each having only the internal combustion engine (internal combustion engine automobiles) as the driving source, the CO₂ emissions during delivery will be relatively high. For hybrid electric vehicles (HEV) and plug-in hybrid electric vehicles (PHEV), CO₂ is also emitted when the internal combustion engine is operated. Examples of fuels for internal combustion engines include gasoline, light oil, and natural gas. In this embodiment, internal combustion engines that use hydrogen as the fuel (hydrogen engines) are not included. However, in a method different from that in this embodiment, the vehicle's CO₂ emissions may be zero when the delivery business operator owns a vehicle with a hydrogen engine.

While CO₂ emissions differ depending on the type of vehicle as described above, the vehicle to be used for product delivery may not be determined at the time of product ordering. Therefore, in this embodiment, the type of vehicle typically used by the delivery business operator for delivery is used as the type of vehicle. This means that CO₂ emissions are low for a delivery business operator with a high percentage of BEVs, and are high for a delivery business operator with a high percentage of internal combustion engine vehicles.

When the user selects a delivery business operator to request product delivery from among a plurality of delivery business operators, the control unit 401 informs the user how much CO₂ emissions vary depending on the selected delivery business operator. To do so, the control unit 401 displays, on the user terminal 20, the amount of increase or decrease from the standard amount in CO₂ emissions corresponding to each of the delivery business operators. In the example shown in FIG. 4, the characters ‘AAA Transportation CO₂ −0.2 g’ are displayed for the item Desired Delivery Company. This indicates that, when AAA Transportation is selected, the CO₂ emissions are 0.2 g less than the standard amount.

Note that even the same delivery business operator may have different vehicle configurations in different areas. Therefore, it is required to calculate the standard amount of CO₂ emissions based on the vehicle configuration of each delivery business operator according to the area where the product is delivered. For example, the amount of increase or decrease in the CO₂ emissions for each delivery business operator is calculated by comparing the average value of CO₂ emissions of all delivery business operators in the area (that is, the average value of CO₂ emissions as a whole) with the average value of CO₂ emissions of each delivery business operator.

Since CO₂ emissions are correlated with the fuel consumption, the CO₂ emissions may be calculated based on the average value of fuel consumption of each delivery business operator. Alternatively, the average value of CO₂ emissions detected during actual driving in the past may be obtained from the delivery server 30 and stored in the auxiliary storage unit 43 of the sales server 40. For example, the average value of CO₂ emissions for delivering one package in a predetermined period may be calculated based on the number of packages delivered in the predetermined period and the amount of fuel consumed in the predetermined period. In addition, the amount of increase or decrease from the average value in CO₂ emissions corresponding to each delivery business operator may be calculated, for example, based on the type and number of vehicles owned by each delivery business operator. In this case, the amount of increase or decrease from the average value in CO₂ emissions may be calculated simply in such a way that, as the ratio of vehicles equipped with internal combustion engines increases, the amount of increase or decrease from the average value in CO₂ emissions corresponding to the delivery business operator increases.

Next, below the item Desired Delivery Timeslot, a plurality of timeslots and ‘Any timeslot’ are displayed to allow the user to select a desired delivery timeslot by tapping the corresponding radio button. ‘Any timeslot’ means that the user may receive the product in any delivery timeslot.

In addition, below the item Desired Delivery Timeslot, the difference from the standard amount in CO₂ emissions corresponding to each timeslot is displayed. When there is no difference from the standard amount, or when there is a difference that is negligibly small, the difference from the standard amount in CO₂ emissions is not displayed. Note that the CO₂ emissions may also differ depending on the timeslot for delivering a product. For example, in the commuter timeslot, the CO₂ emissions may increase due to a congestion. Therefore, in this embodiment, the amount of increase or decrease from the standard amount in CO₂ emissions corresponding to each timeslot is displayed on the user terminal 20. For example, the amount of increase or decrease in the CO₂ emissions corresponding to each timeslot is calculated by comparing the average value of CO₂ emissions for all timeslots (i.e., the average value of CO₂ emissions as a whole) with the average value of CO₂ emissions for each timeslot.

When ‘Any timeslot’ is selected for the desired delivery timeslot, the delivery business operator can select a congestion-free timeslot for delivering the product. This can reduce the CO₂ emissions. In addition, the product can be delivered, for example, when a vehicle with low CO₂ emissions or a vehicle with no CO₂ emissions is available. This can also reduce CO₂ emissions. Therefore, when ‘Any timeslot’ is selected, the CO₂ emissions are minimized. The control unit 401 calculates the difference from the standard amount in CO₂ emissions according to a desired delivery timeslot and presents the calculated difference to the user.

When purchasing a product, the user can select a receiving method of the product. For example, the user can select one of the following: Unattended Delivery, Delivery to Locker, or Face-to-Face Delivery. When Unattended Delivery is specified, the package is delivered non-face-to-face by placing the package in front of the entrance. A delivery locker is a box in a house or apartment complex into which packages can be placed. By placing a package in the delivery locker, the package can be delivered non-face-to-face. The trunk of a vehicle can also be used as a delivery locker. When Unattended Delivery or Delivery to Locker is specified, the package can be delivered even if the user is not at home. On the other hand, when Face-to-Face Delivery is selected, the package cannot be delivered when the user is not at home since the package must be delivered face-to-face. Thus, in this case, redelivery may be necessary. Therefore, the CO₂ emissions may be higher when Face-to-Face Delivery is specified than when Unattended Delivery or Delivery to Locker is specified.

The control unit 401 calculates an increase or decrease in the CO₂ emissions corresponding to each receiving method, for example, by comparing the average value of CO₂ emissions of all receiving methods (that is, the average value of the CO₂ emissions as a whole) with the average value of the CO₂ emissions of each receiving method.

The control unit 401 calculates the amount of increase or decrease from the standard amount in CO₂ emissions corresponding to each of the delivery date, delivery business operator, delivery timeslot, and receiving method as described above. After that, the control unit 401 generates a command to display a web page on which the user performs operations such as the selection of a product delivery method and, then, sends the generated command to the user terminal 20.

When the purchase procedure is completed on the user terminal 20, the control unit 401 requests the delivery server 30 to deliver the product. At this time, the control unit 401 sends a delivery request to the delivery server 30. The delivery request includes the information on the product, the information on the number of products or the size of the product, and the information on the delivery destination.

The user information DB 411 holds the information on users (user information). The user information includes the information necessary to deliver a product to a location specified by the user. The user information includes the information such as user identifiers, user names, user addresses, user's telephone numbers, and user-specified delivery destinations.

The product information DB 412 holds the information on products (product information). The product information includes the information such as product delivery sources, product sizes, product mass, product description, product photos, product prices, and delivery business operators for product delivery.

The vehicle information DB 413 holds the information on the vehicle configuration (vehicle information) for each delivery business operator. The vehicle information includes the number of BEVs, FCEVs, PHEVs, HEVs, and internal-combustion-engine vehicles owned by each delivery business operator in each area. The information stored in the vehicle information DB 413 is obtained from each of the delivery servers 30.

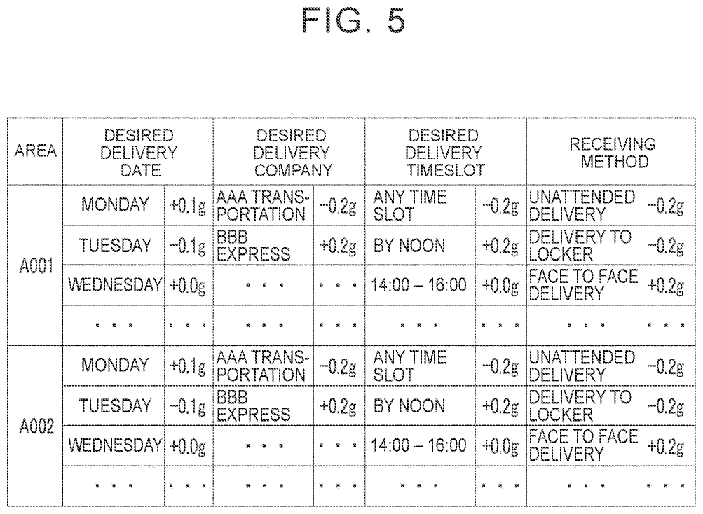

The CO₂ information DB 414 holds the amount of increase or decrease from the standard amount in CO₂ emissions corresponding to each item shown in FIG. 4. This information is calculated by the control unit 401, for example, when a request to send delivery information is received from the user terminal 20 or at every predetermined time interval (for example, every 24 hours), and the calculated information is stored in the CO₂ information DB 414. FIG. 5 is a diagram showing an example of the configuration of data stored in the CO₂ information DB 414. The CO₂ information DB 414 stores the amount of increase or decrease from the standard amount in CO₂ emissions for each area when a desired delivery date, a desired delivery company, a desired delivery timeslot, and a receiving method are selected.

Next, the user terminal 20 includes a control unit 201 as a functional component. The processor 21 of the user terminal 20 performs the processing of the control unit 201 according to the computer program in the main storage unit 22. Note that a part of processing of the control unit 201 may be performed by a hardware circuit. The control unit 201 generates user information. The control unit 201 displays the operation screen on the display 25 to prompt the user to enter user information and, according to the input the user has entered through the input unit 24, generates the user information. The control unit 201 sends the generated user information to the sales server 40. For example, when the user signs up for the system, the control unit 201 may generate user information and send the generated user information to the sales server 40.

The control unit 201 executes the application software, installed in the user terminal 20, to allow the user to purchase a product at an online shop. At this time, the control unit 201 accesses the sales server 40. For example, when a keyword for a product search entered by the user is acquired, the control unit 201 sends the acquired keyword to the sales server 40. After that, when the information on the search result is received from the sales server 40, the control unit 201 displays the search result on the display 25. In addition, when the user taps a product picture displayed on the display 25, the control unit 201 requests the sales server 40 to send the information (product information) for displaying the corresponding product page. When the product information is received from the sales server 40, the control unit 201 displays the product page on the display 25. Then, when the user taps, for example, the ‘Add to Shopping Cart’ button, the control unit 201 sends the information, which indicates that the button has been tapped, to the sales server 40.

When the user taps, for example, the ‘View Shopping Cart’ button, the control unit 201 sends the information, which indicates that the button has been tapped, to the sales server 40. When the information for displaying the shopping cart page is received from the sales server 40, the control unit 201 displays the shopping cart page on the display 25. After that, when the user taps, for example, the ‘Purchase Procedure’ button, the control unit 201 performs processing necessary for the product purchase procedure. When this processing is performed, an order for the product is placed with sales server 40. When the purchase procedure is performed, the control unit 201 displays the screen shown in FIG. 4 on the display 25. When the user selects the items on this screen through the input unit 24 and taps the ‘Confirm’ button, the delivery information is sent to the sales server 40.

On the page for selecting a delivery method, the user can know about the amount of increase or decrease from the standard amount in CO₂ emissions at the time of product delivery. This allows the user, for example, to select a delivery method with lower CO₂ emissions.

Next, the delivery server 30 includes a control unit 301, a delivery information DB 311, and a vehicle information DB 312 as functional components. The processor 31 of the delivery server 30 performs the processing of the control unit 301 according to the computer program in the main storage unit 32. Note that any one of the functional components or a part of its processing may be performed by a hardware circuit.

The delivery information DB 311 and the vehicle information DB 312 are built by managing the data, stored in the auxiliary storage unit 33, by the program of the database management system (DBMS) executed by the processor 31. The delivery information DB 311 and the vehicle information DB 312 are, for example, relational databases.

The delivery information DB 311 holds the information necessary for product delivery. The delivery information DB 311 holds the information such as product delivery destinations, product sizes, product mass, desired delivery dates, desired delivery timeslots, and receiving methods.

The vehicle information DB 312 stores the same information as the vehicle information DB 413 of the sales server 40. The control unit 301 sends the information stored in the vehicle information DB 312 to the sales server 40 in response to a request from the sales server 40.

The control unit 301 acquires, for example, the information on the types of vehicles and the number of vehicles of each type allocated to each area. The control unit 301 may acquire the information on the types of vehicles and the number of vehicles of each type, for example, from the terminals provided at the sales offices in each area. Then, in response to a request from the sales server 40, the control unit 301 sends the information on the types of vehicles allocated to each area and the number of vehicles of each vehicle type.

The control unit 301 generates a plan to deliver a product (hereinafter also referred to as a delivery plan) when the delivery of a product is requested by the sales server 40. The generation of a delivery plan includes the generation of a route on which a vehicle will travel from the delivery source location to the delivery destination location. In addition, the control unit 301 selects a vehicle that delivers each product. In this case, the control unit 301 may select a vehicle either in ascending order of CO₂ emissions or randomly. Vehicles may be allocated according to the route along which the vehicles will travel.

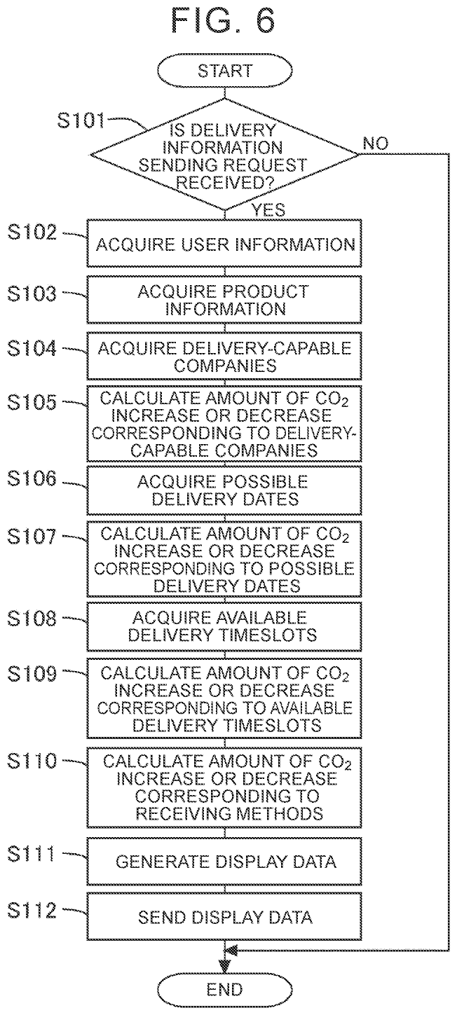

Next, the following describes the processing performed by the control unit 401 of the sales server 40 to display, on the display 25 of the user terminal 20, the amount of increase or decrease from the standard amount in CO₂ emissions corresponding to the product delivery method. FIG. 6 is a flowchart of processing for displaying the amount of increase or decrease from the standard amount in CO₂ emissions corresponding to the product delivery method according to the first embodiment. The processing shown in FIG. 6 is performed in the sales server 40 at predetermined time intervals.

In step S101, the control unit 401 determines whether a delivery information sending request is received from the user terminal 20. The delivery information sending request is a request to send delivery information. The delivery information sending request is an example of “a request to send information to be displayed on the screen for making selections about delivery of a product.” The delivery information sending request includes the information necessary for delivering a product, such as the user ID and the product ID. The delivery information sending request is sent from the user terminal 20 to the sales server 40 when the user makes an input on the user terminal 20 to display a page for selecting the delivery method (for example, when the user taps a button for selecting a delivery method on the shopping cart page or on the purchase page). Therefore, in step S101, the control unit 401 determines whether this delivery information sending request is received. The processing proceeds to step S102 when the determination in step S101 is affirmative, and this routine is terminated when the determination is negative.

In step S102, the control unit 401 acquires the user information. The control unit 401 extracts, from the user information DB 411, the record corresponding to the user ID included in the delivery information sending request. The extracted record identifies the area where the product is to be delivered.

In step S103, the control unit 401 acquires the product information. The control unit 401 extracts, from the product information DB 412, the record corresponding to the product ID included in the delivery information sending request. In step S104, the control unit 401 acquires delivery-capable companies. The control unit 401 acquires delivery-capable companies based on the delivery destination, delivery source, and product. A delivery-capable company is a delivery business operator that can deliver the product in the area in which the delivery destination is included. For example, the control unit 401 may acquire the delivery business operators of the product stored in the product information DB 412. Alternatively, with the delivery-capable companies in each area stored in the auxiliary storage unit 43, the control unit 401 may acquire delivery-capable companies based on this information and the product delivery destination. There may be a plurality of delivery-capable companies.

In step S105, the control unit 401 calculates the amount of CO₂ increase or decrease corresponding to the selectable delivery-capable companies. In step S105, for each of the delivery-capable companies acquired in step S104, the control unit 401 calculates the amount of increase or decrease from the standard amount in CO₂ emissions. The control unit 401 may calculate, for each of the delivery-capable companies, the average value of CO₂ emissions emitted for the delivery of one package in a given period, based on the number of packages delivered in the given period and the amount of fuel consumed in the given period. Then, the control unit 401 calculates the difference between the calculated average value and the standard amount of CO₂ emissions. The average value of CO₂ emissions of all delivery-capable companies (that is, the standard amount of emissions) in the area to which the delivery destination belongs may be calculated in advance and stored in the auxiliary storage unit 43. Then, for each of the delivery-capable companies, the control unit 401 calculates the amount of increase or decrease from the standard amount in CO₂ emissions by subtracting the standard amount of emissions from the CO₂ emissions. The control unit 401 stores the calculated amount of increase or decrease from the standard amount in CO₂ emissions in the CO₂ information DB 414.

In step S106, the control unit 401 acquires possible delivery dates. The possible delivery dates are calculated, for example, based on the product shipping date and the number of days required by the delivery business operator for product deliver. For example, with the number of days required from order completion to shipping stored in the auxiliary storage unit 43 in advance, the product shipping date can be calculated by adding the number of days, required from order completion to shipping, to the current date. The earliest possible delivery date can be acquired by adding the number of days required by the delivery business operator for product delivery to the product shipping date. The control unit 401 acquires dates after this earliest possible delivery date as the possible delivery dates.

In step S107, the control unit 401 calculates the amount of CO₂ increase or decrease corresponding to each of the possible delivery dates. For example, the control unit 401 may acquire the past CO₂ emissions for each day of the week and store the data on the amount of CO₂ increase or decrease for each day of the week in the auxiliary storage unit 43. Then, based on data stored in the auxiliary storage unit 43, the control unit 401 may acquire the amount of CO₂ increase or decrease corresponding to each of the possible delivery dates. The amount of increase or decrease from the average value in CO₂ emissions corresponding to the case where the desired delivery date is not specified may be set, for example, to the same value of the day with the lowest CO₂ emissions or to a value even smaller than that value. The control unit 401 stores the calculated amount of increase or decrease from the standard amount in CO₂ emissions in the CO₂ information DB 414.

In step S108, the control unit 401 acquires available delivery timeslots. The available delivery timeslots are determined, for example, by the delivery business operator, sent from the delivery server 30 to the sales server 40, and then stored in the auxiliary storage unit 43.

In step S109, the control unit 401 calculates the amount of CO₂ increase or decrease corresponding to each of the available delivery timeslots. For example, the control unit 401 may acquire the past CO₂ emissions for each of the delivery timeslots and store the data on the amount of CO₂ increase or decrease for each of the delivery timeslots in the auxiliary storage unit 43. Then, based on the data stored in the auxiliary storage unit 43, the control unit 401 may acquire the amount of CO₂ increase or decrease corresponding to each of the available delivery timeslots. The amount of increase or decrease in CO₂ emissions corresponding to the case where the desired delivery timeslot is not specified may be set, for example, to the same value of the timeslot with the lowest CO₂ emissions or to a value even smaller than that value. The control unit 401 stores the calculated amount of increase or decrease from the standard amount in CO₂ emissions in the CO₂ information DB 414.

In step S110, the control unit 401 calculates the amount of CO₂ increase or decrease corresponding to each of the “receiving methods.” For example, the control unit 401 may acquire the past CO₂ emissions for each of the receiving methods and store the data on the amount of CO₂ increase or decrease for each of the receiving methods in the auxiliary storage unit 43. Then, based on the data stored in the auxiliary storage unit 43, the control unit 401 may acquire the amount of CO₂ increase or decrease corresponding to each of the receiving methods. The control unit 401 stores the calculated amount of increase or decrease from the standard amount in CO₂ emissions in the CO₂ information DB 414.

In step S111, the control unit 401 generates display data. The display data is the data used to display a page where the user selects a delivery method. That is, the display data is the data used to display the screen shown in FIG. 4. The display data includes the information on delivery-capable companies, possible delivery dates, available delivery timeslots, receiving methods, and the amount of increase or decrease from the standard amount in CO₂ emissions corresponding to each of these items. The display data may include a command to display this data on the user terminal 20. In step S112, the control unit 401 sends the generated display data to the user terminal 20.

According to this embodiment, when selecting a product delivery method, the user can know the amount of increase or decrease from the standard amount in CO₂ emissions corresponding to the selected delivery method as described above. As a result, the user can select a delivery method with low CO₂ emissions. In addition, an increase in the number of users who select delivery business operators with lower CO₂ emissions will motivate delivery business operators to use vehicles with lower CO₂ emissions. As a result, delivery business operators will purchase more vehicles with lower CO₂ emissions. In addition, an increase in the number of users who do not specify a desired delivery date or a desired delivery timeslot allows delivery business operators to deliver products more efficiently. A selection of delivery to locker as the receiving method will motivate the user to purchase a delivery locker. As a result, more users will purchase a delivery locker. In this way, CO₂ emissions from vehicles used for product delivery can be reduced.

### OTHER EMBODIMENTS

The above embodiment is merely an example, and the present disclosure can be modified as appropriate for implementation within the spirit of the present disclosure.

The processing and the units described in the present disclosure can be freely combined for implementation as long as there is no technical contradiction.

In addition, the processing described as being performed by one device may be shared and performed by a plurality of devices. Conversely, the processing described as being performed by different devices may be performed by one device. In a computer system, it is possible to flexibly change what hardware configuration (server configuration) is used to implement each function. For example, the sales server 40 may have a part or all of the functions of the delivery server 30.

In the first embodiment, the amount of increase or decrease from the standard amount in CO₂ emissions is presented to the user. Instead of this, the CO₂ emissions themselves may be presented to the user. That is, the absolute amount may be presented instead of the relative amount.

In the first embodiment, the amount of increase or decrease from the standard amount in CO₂ emissions only for the area to which the delivery destination belongs is presented to the user. Instead of this, the amount of increase or decrease from the standard amount in CO₂ emissions from the delivery source to the delivery destination may be presented to the user, or the CO₂ emissions themselves from the delivery source to the delivery destination may be presented to the user.

In the first embodiment, when the amount of increase or decrease from the standard amount in CO₂ emissions is provided to the user, the amount of increase or decrease from the average value of the area to which the delivery destination belongs is provided to the user. Instead of this, the amount of increase or decrease from the standard amount in CO₂ emissions to the actual delivery destination of the product may be calculated for, and presented to, each user.

CO₂ emissions, though expressed in grams in the above embodiment, may be expressed in any unit of measure. For example, CO₂ emissions may be expressed using any of the following expressions: how long does it take for trees to absorb CO₂, how many trees are needed to absorb CO₂, how many trees are needed for delivery, how many trees are cut down for delivery, how much of forest will be lost for delivery, or how much Antarctic ice will melt for delivery.

The present disclosure can also be implemented by supplying a computer program that implements the functions described in the above embodiments to a computer so that one or more processors of the computer can read and execute the program. Such a computer program may be provided to the computer using a non-transitory computer-readable storage medium that can be connected to the system bus of the computer or may be provided to the computer via a network. The non-transitory computer-readable storage medium includes any type of disk, such as a magnetic disk (floppy (registered trademark) disk, hard disk drive (HDD), etc.) and an optical disc (CD-ROM, DVD disc, Blu-ray disc, etc.), and any type of medium suitable for storing electronic instructions such as a read only memory (ROM), a random access memory (RAM), an EPROM, an EEPROM, a magnetic card, a flash memory, and an optical card.

What is claimed is:

1. An information processing device comprising a control unit configured
to receive, from a user terminal, a request to send information to be displayed on a screen for making selections about delivery of a product; and
in response to the request, to output information that is to be displayed on the screen for making selections about delivery of a product and that is about an amount of carbon dioxide, the amount of carbon dioxide corresponding to items selectable by a user who purchases the product, and being emitted from a vehicle that delivers the product.

2. The information processing device according to claim 1, wherein the control unit is configured to send a command to the user terminal to display, on the user terminal, the items selectable by the user who purchases the product for a delivery method of the product and values associated with carbon dioxide emissions corresponding to the items.

3. The information processing device according to claim 1, wherein the information about the amount of carbon dioxide emitted from the vehicle that delivers the product includes information on a difference from a standard amount in carbon dioxide emissions.

4. The information processing device according to claim 3, wherein the standard amount of carbon dioxide emissions includes an amount of carbon dioxide emitted from the vehicle when the product is delivered again because the user is not at home when the product is delivered.

5. The information processing device according to claim 1, wherein:
the items selectable by the user include information on delivery dates selectable by the user; and
the control unit is configured to output information on an amount of carbon dioxide that corresponds to each of the delivery dates selectable by the user and that is emitted from the vehicle.

6. The information processing device according to claim 5, wherein the control unit is configured to output the information on the amount of carbon dioxide emitted from the vehicle so that the amount of carbon dioxide emitted from the vehicle is greater when the user specifies the delivery date than when the user does not specify the delivery date.

7. The information processing device according to claim 1, wherein:
the items selectable by the user include information on delivery business operators selectable by the user; and
the control unit is configured to output information on an amount of carbon dioxide that corresponds to each of the delivery business operators selectable by the user and that is emitted from the vehicle.

8. The information processing device according to claim 1, wherein:
the items selectable by the user include information on delivery timeslots selectable by the user; and
the control unit is configured to output information on an amount of carbon dioxide that corresponds to each of the delivery timeslots selectable by the user and that is emitted from the vehicle.

9. The information processing device according to claim 8, wherein the control unit is configured to output the information on the amount of carbon dioxide emitted from the vehicle so that the amount of carbon dioxide emitted from the vehicle is greater when the user specifies the delivery timeslot than when the user does not specify the delivery timeslot.

10. The information processing device according to claim 1, wherein:
the items selectable by the user include information on receiving methods of the product selectable by the user; and
the control unit is configured to output information on an amount of carbon dioxide that corresponds to each of the receiving methods of the product selectable by the user and that is emitted from the vehicle.

11. The information processing device according to claim 10, wherein the control unit is configured to output the information on the amount of carbon dioxide emitted from the vehicle so that the amount of carbon dioxide emitted from the vehicle is greater when the user selects a face-to-face receiving method than when the user selects a non-face-to-face receiving method.

12. An information processing method performed by a computer, the information processing method comprising:
receiving, from a user terminal, a request to send information to be displayed on a screen for making selections about delivery of a product; and
in response to the request, outputting information that is to be displayed on the screen for making selections about delivery of a product and that is about an amount of carbon dioxide, the amount of carbon dioxide corresponding to items selectable by a user who purchases the product, and being emitted from a vehicle that delivers the product.

13. The information processing method according to claim 12, wherein the computer is configured to send a command to the user terminal to display, on the user terminal, the items selectable by the user who purchases the product for a delivery method of the product and values associated with carbon dioxide emissions corresponding to the items.

14. The information processing method according to claim 12, wherein the information about the amount of carbon dioxide emitted from the vehicle that delivers the product includes information on a difference from a standard amount in carbon dioxide emissions.

15. The information processing method according to claim 14, wherein the standard amount of carbon dioxide emissions includes an amount of carbon dioxide emitted from the vehicle when the product is delivered again because the user is not at home when the product is delivered.

16. The information processing method according to claim 12, wherein:
the items selectable by the user include information on delivery dates selectable by the user; and
the computer is configured to output information on an amount of carbon dioxide that corresponds to each of the delivery dates selectable by the user and that is emitted from the vehicle.

17. The information processing method according to claim 12, wherein:
the items selectable by the user include information on delivery business operators selectable by the user; and
the computer is configured to output information on an amount of carbon dioxide that corresponds to each of the delivery business operators selectable by the user and that is emitted from the vehicle.

18. The information processing method according to claim 12, wherein:
the items selectable by the user include information on delivery timeslots selectable by the user; and
the computer is configured to output information on an amount of carbon dioxide that corresponds to each of the delivery timeslots selectable by the user and that is emitted from the vehicle.

19. The information processing method according to claim 12, wherein:
the items selectable by the user include information on receiving methods of the product selectable by the user; and
the computer is configured to output information on an amount of carbon dioxide that corresponds to each of the receiving methods of the product selectable by the user and that is emitted from the vehicle.

20. The information processing method according to claim 19, wherein the computer is configured to output the information on the amount of carbon dioxide emitted from the vehicle so that the amount of carbon dioxide emitted from the vehicle is greater when the user selects a face-to-face receiving method than when the user selects a non-face-to-face receiving method.
